(19) United States
(12) Patent Application Publication
(10) Pub. No.: US 2005/0255888 A1
(43) Pub. Date: Nov. 17, 2005

(54) Base station for a mobile telecommunications network employing diversity and method of operation

(76) Inventors: Stephen Edward Cooper, Leighton Buzzard (GB); Neil Gordon Grant, Swindon (GB); Marcus Roderick Kirschner, Chippenham (GB)

Correspondence Address: Lucent Technologies Inc.;Docket Administrator, Room 3J-219, 101 Crawfords Corner Road, Holmdel, NJ, 07733-3030, US

(21) Appl. No.: 10/846,231

(22) Filed: May 14, 2004

(51) Int. Cl. H04B 1/02

(52) U.S. Cl. 455/561; 455/101

(57) ABSTRACT

A base station for a mobile telecommunications network employing diversity reception comprises a plurality of radios, each having a plurality of diversity paths. Instead of each of the radios receiving signals from diversity antennas in the same sector, each radio receives signals from different sectors. Thus, if one of the radios becomes inoperative; diversity reception is affected in a plurality of sectors rather than service being completely removed from any one sector.

### TECHNICAL FIELD

This invention relates to base stations for mobile telecommunications networks employing receive diversity or employing receive and transmit diversity, and more particularly to provisions for improving reliability and/or reducing the costs associated with providing reliability in such base stations.

### BACKGROUND OF THE INVENTION

A cell in a mobile network is normally divided into sectors, typically three in number, and the base station covering the cell has a directional antenna arrangement for transmitting signals to, and receiving signals from, the several sectors. Each sector has associated radio equipment for providing the radio signals for transmission to the respective sector and for receiving the radio signals from that sector.

Since radio signals at the wavelengths employed by mobile telecommunications networks are subject to position-dependent fading due, for example, to multi-path effects, it is also customary to employ diversity reception at the base station, and preferably also diversity transmission.

In diversity reception, each sector has two (or more) separately located antennas, where an “antenna” may include a plurality of antenna elements, which independently receive signals from mobile units in the sector. Since the fading is position-dependent, it is unlikely that the signal from a mobile unit will have a null at the locations of both (or all) of the antennas, so it should always be possible to pick out a satisfactory signal.

In a CDMA system employing diversity transmission, one antenna transmits to a mobile unit using one spectrum-spreading code, and another antenna transmits using a different spectrum-spreading code. The mobile unit demodulates the signals from both transmit antennas, and optimally combines them to produce a better output.

In a TDMA system employing diversity transmission, the antenna used to transmit a timeslot may be switched on a frame by frame basis. If the mobile unit is stationary, the probability is that the signal from both/all antennas will not be nulled, even if the signal from one of the antennas to the mobile is in a null. Use of interleaving and error correction allow recovery of some/all data from the timeslot that was lost, thus producing a better output.

The type of diversity described above, in which the diversity antennas are spatially separated, is termed “spatial diversity”. An alternative form of diversity is “polarization diversity” in which the diversity antennas have different polarizations, for example vertical and horizontal, or ±45° slant polarization.

Thus, in a system using both diversity transmission and reception, whether spatial diversity or polarization diversity, each sector has a respective radio with two or more signal paths, known as “diversity paths”, both for reception and for transmission.

Since each such radio includes a considerable amount of circuitry common to both diversity paths, a fault in a radio would probably put the whole sector out of action, not just one diversity path. Furthermore, even if a fault occurred which did not affect all service for the whole sector, removing the radio, or a circuit card from the radio, for repair or maintenance would probably do so. To avoid this it is customary to employ hardware redundancy and fail-safe circuitry. Clearly, the more hardware redundancy that is employed, and the more fail-safe the circuitry is made, the higher the cost.

Thus there is a trade-off between system reliability and cost. It is an object of the invention to improve the terms of that trade-off.

### SUMMARY OF THE INVENTION

A base station according to an embodiment of the invention includes a plurality of antennas where for diversity operation at least two antennas are associated with each sector, and a plurality of radios, each having a plurality of diversity paths, and where one antenna in a sector is connected to a diversity path of one of the radios and another antenna in the same sector is connected to a diversity path of another of the radios.

A method according to an embodiment of the invention comprises at a radio at a base station that has a plurality of radios and a plurality of antennas for diversity operation, receiving signals from an antenna in one sector and from an antenna in a different sector and preferably also providing signals for transmission to different antennas in the same sector from different radios.

Thus, if a fault causes a radio to become inoperative, it does not completely remove service from any sector, but merely affects diversity reception in a plurality of sectors.

### BRIEF DESCRIPTION OF THE DRAWING

Embodiments of the invention will now be described by way of example with reference to the accompanying drawings, in which:

FIG. 1 shows, in diagrammatic form, a cell of a mobile telecommunications network divided into sectors as known in the prior art;

FIG. 2 shows, in diagrammatic form, the base station of the cell of FIG. 1 showing the diversity antennas for the sectors as known in the prior art;

FIG. 3 shows, in block diagram form, the radio and channel portions of the base station of FIG. 2;

FIG. 4 shows the radio portion of the base station of FIG. 2 modified according to a first embodiment of the invention; and

FIG. 5 shows the radio portion of the base station of FIG. 2 modified according to a second embodiment of the invention.

### DETAILED DESCRIPTION

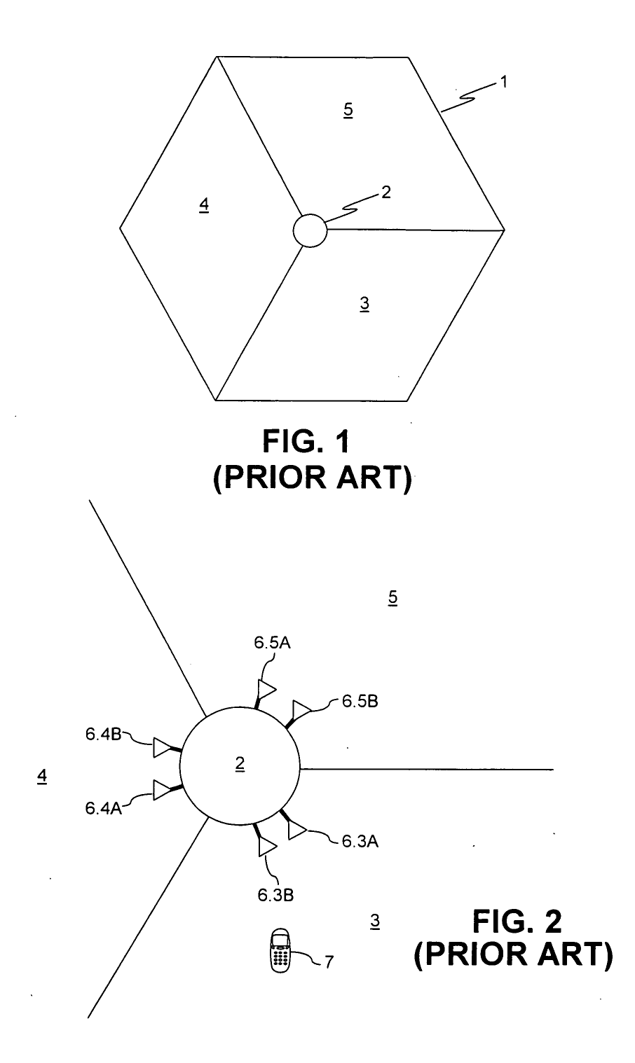

FIG. 1 shows a cell 1 of a mobile telecommunications network. A base station 2 is centrally positioned within the cell 1. The cell 1 is divided into three sectors, 3, 4 and 5. As shown in FIG. 2, the base station 2 has two antennas 6.3A and 6.3B, each covering sector 3, antennas 6.4A and 6.4B covering sector 4 and antennas 6.5A and 6.5B covering sector 5. The antennas 6.3A and 6.3B are physically separated from each other by a sufficient distance that position-dependent fading due to multi-path effects is uncorrelated. A mobile unit 7 which is for the time being in sector 3 of cell 1 transmits a signal which is received at both antennas 6.3A and 6.3B. If the mobile unit 7 moves into a position within sector 3 such that the signal it transmits has a null at the location of antenna 6.3A there will generally not be a null at the position of antenna 6.3B, so the signal is still received by the base station 2. Signals for the mobile unit 7 are transmitted from antenna 6.3A using one spreading code and by antenna 6.3B using another spreading code. If the mobile unit 7, moves into a position where there is a null of the signal from antenna 6.3A it still receives a signal from antenna 6.3B. Thus it is able to receive signals, protected from the effects of position-dependent fading. Similarly, such protection in sectors 4 and 5 is provided by antennas 6.4A and 6.4B and by antennas 6.5A and 6.5B respectively.

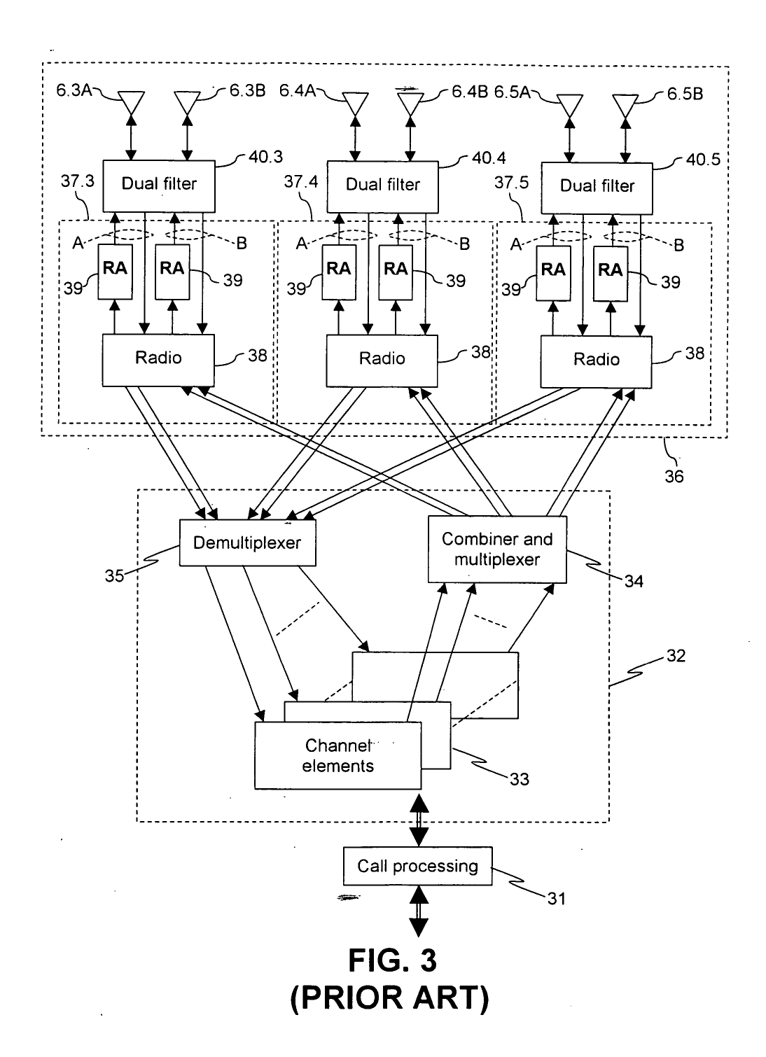

FIG. 3 shows, in diagrammatic form, the working parts of a known base station 2. Basically, the base station comprises a call processing portion 31, which is connected to the network (not shown), a traffic processing portion 32 and a radio portion 36.

The present invention is not concerned with the call processing portion, 31 which is therefore not described further. The call processing portion of a base station may be exactly the same as the call processing of a conventional base station.

Signals from the call processing portion 31 are passed to the traffic processing portion 32, which comprises channel elements 33, combiner and multiplexer apparatus 34 and demultiplexer apparatus 35. The signals from the call processing portion 31 are first received by the channel elements 33 which perform channel coding functions for multiple traffic channels. Thus, incoming traffic in a call for a particular recipient, such as mobile unit 7 of FIG. 2, will be encoded using the spectrum spreading codes used by that recipient, and similarly with traffic for other recipients in the cell.

The coded signals from the channel elements 33 are passed to the combiner and multiplexer apparatus 34 which includes circuitry that allows the transmit data for the same sector and carrier to be additively combined, multiplexed with other carrier data and appropriately directed as will be further described below.

Signals received from the radio portion are connected to the demultiplexer apparatus 35 which contains circuitry for demultiplexing the uplink data from the radio portion, as received from the diversity paths of the sectors and directing the signals to the appropriate channel elements 33.

The radio portion 36 consists of three sections 37.3, 37.4 and 37.5, or more generally, one section corresponding to each of the sectors 3, 4 and 5. Each section 37.3, 37.4, 37.5 comprises a radio 38 and a pair of radio frequency amplifiers 39, one for each diversity path.

The radio 38 in a given one of the sections, e.g., section 37.3, receives signals from the combiner and multiplexer apparatus 34 directed to both diversity channels, A and B, of the corresponding sector 3 and derives respective modulated radio frequency signals for transmission by each of the diversity antennas 6.3A and 6.3B of the sector. The radio frequency signals for transmission by each diversity antenna of each sector are amplified by a respective radio frequency amplifier 39. The amplified radio frequency signals for transmission in each sector are connected, via a dual filter panel 40.3, 40.4, 40.5 corresponding to the sector, to the respective diversity antennas.

The dual filter panel comprises two pairs of transmit/receive filters. Each transmit/receive filter allows a transmitter and a receiver to share a single antenna, whilst protecting the receiver from damage/strong-signal overload by the transmitter. The dual filter panel may also contain Low Noise Amplifiers (LNA's) to amplify the receive signals, but the inclusion of the LNA's is not mandatory.

For each sector, e.g., sector 3, incoming radio frequency signals from the diversity antennas 6.3A and 6.3B are connected via the dual filter panel 40.3 to the radio 38 in the corresponding section 37.3, and the received signals from the radio 38 are directed to the demultiplexer apparatus 35 which directs them to the appropriate one of the channel elements 33 where diversity processing and decoding are carried out.

The radio 38 in a section is a multi-channel radio and handles all of the channels for the respective sector, including both diversity paths. A fault in the radio 38 in a section is likely to affect all of the channels, since much of the circuitry is common to all of them. Therefore, there is a danger that all service in the sector may be lost. It is well known to use hardware redundancy and fail-safe circuitry to reduce the risk of such loss of service.

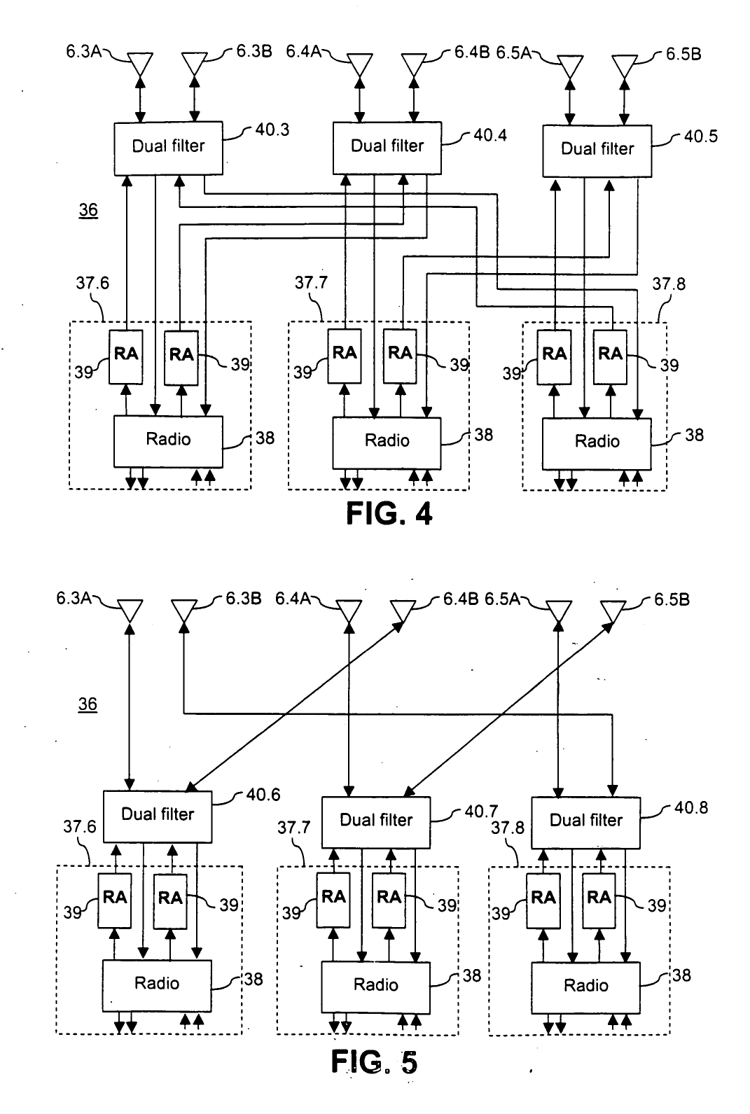

FIG. 4 shows the radio portion 36 of the base station of FIG. 3 modified according to one embodiment of the invention.

As shown in FIG. 4, the radio portion still comprises three sections 37.6, 37.7 and 37.8, but, although the sections 37.6, 37.7, 37.8, and in particular the radios 38, are equinumerous with the sectors, they are no longer assigned to respective sectors on a one-to-one basis. Thus, in the embodiment shown, one diversity path of section 37.6 is connected, via dual filter panel 40.3, to one of the diversity antennas 6.3A in sector 3 whereas the other diversity path in the same section 37.6 is connected, via dual filter panel 40.4, to one of the diversity antennas 6.4B in sector 4. Thus, whereas in the base station of FIG. 3 each diversity path in a section 37.3 processes signals for, and from, a respective diversity antenna 6.3A, 6.3B in the same sector 3, in the base station of FIG. 4 the diversity paths in a section 37.6 process signals for, and from, respective diversity antennas 6.3A and 6.4B in different sectors 3 and 4. Similarly, the diversity paths in section 37.7 process signals relating to different respective sectors 4 and 5 and the diversity paths in section 37.8 process signals relating to different respective sectors 5 and 3.

If a fault occurs in one of the radios 38, e.g., the radio 38 in section 37.6, even if the radio completely fails to function, this does not have the effect of completely depriving a sector of service. All that happens is that one of the diversity paths in sector 3 fails and one of the diversity paths in sector 4 fails. Thus, instead of one sector being taken out of service, the service in two sectors is adversely affected, but still maintained, albeit at a lower level of quality. Thus the effect of a failure in a radio 38 is spread more thinly across more than one sector. The consequences are less catastrophic and therefore more tolerable.

FIG. 5 shows a second embodiment in which the dual filter panels 40.6, 40.7, 40.8 are also used for diversity paths in different sectors. As shown in FIG. 5, the Dual filter panels 40.6, 40.7, 40.8 are associated with respective sections 37.6, 37.7, 37.8 instead of being associated with respective sectors. Dual filter panel 40.6, for example, is associated with section 37.6. Thus one diversity path of section 37.6 is connected via filter panel 40.6 to antenna 6.3A in sector 3 and, the other is connected via the same filter panel 40.6 to antenna 6.4B in sector 4.

In both embodiments traffic for the various diversity paths and sectors needs to be directed by the combiner and multiplexer 34 (FIG. 3) to the appropriate radio, so the combiner and multiplexer 34 needs to be appropriately reconfigured, or the connections between the traffic processing portion 32 and the radio portion 36 need to be rearranged. Similarly traffic from different diversity paths related to the same channel, which come from different radios 38 need to be directed by the demultiplexer 35 to the appropriate channel element 33.

The present invention may be embodied in other specific forms without departing from its spirit or essential characteristics. The described embodiments are to be considered in all respects only as illustrative and not restrictive. For example, whilst the described embodiments employ spatial diversity and CDMA, the invention can be used a system that employs polarization diversity and/or TDMA. The scope of the invention is, therefore, indicated by the appended claims rather than by the foregoing description. All changes that come within the meaning and range of equivalency of the claims are to be embraced within their scope.

1. A base station comprising:
a plurality of antennas for diversity operations, at least two different of said plurality of antennas being associated with each of a plurality of sectors, and
a plurality of radios each having a plurality of diversity paths, at least one of said antennas that is associated with a sector being connected to a diversity path of one of said radios and at least another of said associated antennas that is associated with the same sector being connected to a diversity path of another of said radios.

2. The base station of claim 1 wherein said radios are equinumerous with said sectors and each of said radios has one diversity path connected to an antenna in one sector and another diversity path connected to an antenna in a different sector.

3. The base station of claim 2 including a plurality of filter panels, said filter panels being equinumerous with said sectors, said radios being connected to said antennas via said filter panels.

4. The base station of claim 3 wherein said filter panels are associated with respective sectors, such that connections to the antennas in any sector are via the filter panel associated with that sector.

5. The base station of claim 3 wherein said filter panels are associated with respective ones of said radios, such that connections between each of said radios and the antennas to which it is connected are via the filter panel associated with that radio.

6. A method comprising:
at a radio at a base station that has a plurality of radios and a plurality of antennas for diversity reception in a plurality of sectors, receiving signals from at least one of the antennas that is associated with one of the sectors and from at least one of the antennas that is associated with a different one of the sectors.

7. The method of claim 6 further comprising providing signals for transmission from different ones of the antennas in the same sector from different ones of the radios.

8. The method of claim 7 wherein the base station includes a plurality of filter panels, each associated with a respective one of the sectors, and wherein signal connections between antennas in each of the sectors and the radios are via the filter panel associated with the sector.

9. The method of claim 7 wherein the base station includes a plurality of filter panels, each associated with a respective one of the radios, and wherein signal connections between each of the radios and ones of the antennas are via the filter panel associated with the radio.
